(19) United States
(12) Patent Application Publication
(10) Pub. No.: US 2015/0211510 A1
(43) Pub. Date: Jul. 30, 2015

(54) WATER REMOVAL STORAGE SYSTEM AND METHOD

(71) Applicant: WATERFORD INSTITUTE OF TECHNOLOGY, Waterford (IE)

(72) Inventors: Philip Walsh, Waterford (IE); Austin Coffey, Waterford (IE); Niall Murphy, Co Waterford (IE)

(73) Assignee: WATERFORD INSTITUTE OF TECHNOLOGY, Waterford (IE)

(21) Appl. No.: 14/417,251

(22) PCT Filed: Jul. 29, 2013
(86) PCT No.: PCT/EP2013/065936

§ 371 Date: Jan. 26, 2015

(30) Foreign Application Priority Data
Jul. 27, 2012 (GB) 1213421.9

(51) Int. Cl. F04B 49/06; G05D 7/06

(52) U.S. Cl. CPC F04B 49/06; G05D 7/0629

(57) ABSTRACT

The invention provides water removal and storage system adapted for use in a building structure, said system comprising a water storage vessel for the removal and storage of water from one or more supply lines and resupply of water stored on demand. The system of the invention provides either a solution to the problems of flooding due to pipe rupture, interrupted water supply due to freezing, pipe rupture due to freezing, and water damage due to uncontrolled thaw. In one aspect the invention provides a controller adapted to receive control signals remotely, said signals control the valve to regulate the water supply pressure and/or flow rate to a desired set point.

### FIELD OF THE INVENTION

The invention relates to a water removal and storage system and method. In particular the invention relates to a water removal and storage system and method to prevent domestic and/or industrial pipes freezing during cold weather conditions. The invention also relates to a water removal and storage system to prevent damage when domestic and/or industrial pipes leak and a smart-valve implementation to provide quantised water supply pressures.

### BACKGROUND TO THE INVENTION

Due to changes in the winter weather, Ireland and other countries are experiencing colder spells resulting in ground frost penetrating deeper into the soil. The lowest recorded air temperature in Ireland for December 2010 was 17.5° C. below zero in Straide Co. Mayo, Ireland. Many houses now have the problem of mains water pipes freezing, incurring flooding and water damage as a result. This can be attributed, in cases, where the water pipes are not buried at the recommended depth and ground frost is penetrating to the pipe depth.

Pipe freezing occurs when the water remains stationary at an area of pipe that is below 0° C. for a long enough time. When the almost freezing water is moving, it is moving away from the colder spot, being replaced by the warmer water from the main water pipe, thus preventing the water in the pipe from freezing. However, the water in the pipe is not contained long enough for the water to freeze. When the water is stationary it can then freeze creating an ice plug in the pipe. The pipe can burst if two plugs of ice are formed. These plugs will expand along the pipe, increasing the pressure of the trapped water in between (water is not compressible), causing the pipe to burst.

A typical water supply to a house in Ireland and the UK is fed from a 13 mm internal bore plastic pipe. With a large house this pipe could be up to 25 mm to provide a larger flow. The water is typically supplied at minimum 12 litres per minute at minimum 1 bar. Although the temporary loss of water supply could be a nuisance, this could last longer than a few days before the pipe defrosts. If the pipe were to burst, every minute there is the potential to lose 12 litres of water. Unnoticed this could amass to a loss of 121 cubic meters or 120,960 litres over a week.

To remedy these problems, rather than digging and dropping the water pipe below the ground frost level a number of solutions have been proposed:

Bleeding, uses a valve to allow a small amount of water to flow into a drain to prevent the pipe from freezing (a more controlled method of leaving a tap running). It involves a valve controlled by a thermostat to open and divert a small but constant flow of water from the pipe to keep the water flowing. Since water is always moving, the colder water is replaced by the warmer water from the mains preventing any potential freezing point in the pipe work. The water is diverted to the sewer or treatment plant. The problem with bleeding is that it wastes water leading to shortages. The waste water can dilute the water going into the sewerage plant or put the treatment system under pressure from itself freezing due the volume of water in the tank. As the clean water is now directly connected to the sewage pipe the risk of cross contamination can occur.

A second solution is to use a dump valve that is thermally operated to close the input supply and dump the contents of the pipe to keep the pipe empty, opening only when there is an increase in temperature. The valve uses a thermal actuator (wax) that will close the incoming mains water and then dumps the water in the pipe going to building to a drain/soak pit. Two types of valve are available in various sizing, one valve uses the temperature of the water, and the other uses the air temperature to monitor the valve. A typical valve from Ogontz can be controlled for temperatures between 35° F. (1.7° C.) and 255° F. (124° C.) in 5° F. increments. Differential from fully open to fully closed is typically 10° F. to 15° F. Valve opens/closes gradually. A problem with the dump valve is that the valve actuates water is not available to the building. The drain water has to be lost. The temperature has to rise by up to 4 degrees Celsius before it is fully open (a slight increase opens the valve slightly).

A third solution is inline heat tracing, which uses a heat cable inserted onto or inside the problem water pipe to keep the stationery water above 0 degrees C. This system uses a self regulating or constant wattage heat cable inserted in the pipe, using a thermostat to control the times that the cable is on. Normally used on the outside of pipe work but has been adapted to use inside pipes. A problem with this approach is that it is difficult to install and associated costs when running. Needs local power supply with Residual Current Circuit Breaker (RCD). The heating cable cannot pass through valves and cannot be used in all pipe dimensions, as well as restricting the water flow.

Another solution uses an in-line heat cable where a blanket uses a thermally controlled electrically heated blanket to cover the pipe. This system uses Heat Tape that is taped or twisted onto the outside of the pipe and then covered in insulation to concentrate the heat on the pipe rather than the air. A thermostat either on the pipe monitoring the water temperature or using air temperature is used to economically control the power used. Problems with this approach is that it cannot be retrofitted to buried pipe work and has associated operating costs when running. Needs local power supply with Residual Current Circuit Breaker (RCD).

Another problem with water pipes is that there are no systems that effectively detect leak detection to provide flood prevention, for example due to wear and tear of the pipe or whether a tap has been left on in a building that causes flooding.

A further problem with water supply systems or networks is that facilities are not in place to regulate the water supply pressure to individual houses or buildings. This is desirable for Water Authorities for a number of reasons as it would provide greater control of water supply in a network. This is a particular problem as water is now seen as a valuable commodity and as such needs to be regulated and controlled by the Water Authority responsible for providing the supply.

It is therefore an object of the invention to provide a system and method to overcome at least one or more of the above mentioned problems.

### SUMMARY OF THE INVENTION

According to the invention there is provided, as set out in the appended claims, a water removal and storage system adapted for use in a building structure, said system comprising a water storage vessel adapted for the removal and storage of water from one or more supply lines and resupply of water stored on demand.

In one embodiment the water removal and storage system comprises:
a valve adapted to shut off a mains water supply line from at least one water pipe in the building structure;
a pump adapted to push or pull sufficient water from the water pipe into the water storage vessel; and
a flow transducer, a pressure transducer and a temperature transducer interfaced with a microcontroller, wherein at least one transducer provides measurement data to the microcontroller to control operation of the valve and the pump.

In one embodiment the water storage vessel provides a pseudo-storage water system. In the context of this invention the pseudo-storage implies storage of a small quantity water to indicate the request of the end-user to replenish the supply pipe merely by turning on a tap rather than a switch or other complex command. Pseudo-storage also provides a degree of hysteresis to reduce the frequency of discharging/charging of the supply pipe. Pseudo-storage removes the legislation associated with the storage of potable water, (the water pseudo-stored in the accumulator has the same form as that stored in the supply pipe).

The system of the invention provides a solution to the problems of:
flooding due to pipe rupture
interrupted water supply due to freezing,
pipe rupture due to freezing, and
water damage due to uncontrolled thaw.
Retrofitable system.
Quick installation.
Water usage remote monitoring.
Leak detection.
Remote water supply pressure and/or flow control.
Wide area water supply network zoning and platform for quantised tariffs.
Protection of consumer water peripherals.

In addition, this system can be adapted to be an intelligent learning system for continuous monitoring of fluid dynamics and deviations from usual, historical trends.

The system of the present invention consists of a self-contained system with a water inlet and outlet, allowing the system to be retrofitted into existing plumbing systems, both residential and industrial. The system of the invention is tolerant of all external piping configurations. The system uses free volume to prevent ice expansion and hence, bursting of frozen pipe systems. The system operates automatically without user intervention. The system can undergo test/validation irrespective of season/ambient temperature.

In one embodiment the water flows through the storage vessel during normal operating conditions.

In one embodiment the system is configured to operate at a range of ambient temperatures whereby freeze pipe rupture is prevented in said at least one water pipe.

In one embodiment the storage vessel is pressurised and adapted to allow water to flow on said at least one pipe until the mains water is up to a desired pressure.

In one embodiment the temperature transducer is adapted to operate the valve with means to switch the valve on and off depending on the temperature conditions.

In one embodiment the flow and pressure transducers are adapted to control the opening and closing of the valve thereby filling or emptying of the storage vessel.

In one embodiment the flow and pressure transducers supply data to the micro controller to provide automated operation of the filling or emptying of the storage vessel dependent on the data supplied to the microcontroller.

In one embodiment the flow and pressure transducers are adapted to compensate for water losses in the building pipe-work by running the system to maintain a charge in the vessel.

In one embodiment the accumulator comprises of an air chamber that is separated from the water by a diaphragm and inflated at a slightly lower pressure than the water pressure, such that when water is forced into the accumulator the diaphragm is expanded. The volume of water pseudo-stored is equal to the distortion of the expanded diaphragm.

In one embodiment when water is required the accumulator will discharge by action of the diaphragm contracting, forcing water out of the accumulator for use.

In one embodiment, the internals of the accumulator is designed to eliminate the possibility of any residual or remnant water during normal operation to comply with regulations applied to potable water systems.

In one embodiment the flow transducer, the pressure transducer and the temperature transducer temperature sensor, a flow sensor and a pressure sensor combined to provide data that determine a water leak in said at least one water pipe.

In one embodiment the system is adapted to be retrofitted into existing plumbing systems of said building structure. A retro fit involves the least amount intrusion and cost to the client.

In one embodiment there is provided an admittance valve to facilitate water removal from the at least one water pipe.

In one embodiment an accumulator vessel is provided to pseudo-store removed water and provide a controlled pressure overhead in the system.

In one embodiment the accumulator vessel is positioned substantially in series with the mains water supply and adapted to be used in the treatment of potable water.

In one embodiment the system comprises one or more motorised valves placed in situ in said building, (at any form of storage or water reservoir, eg hot water cistern or attic storage tank. Must not be applied to any expansion tanks used in heating systems) and adapted to determine a leak in said at least one pipe at different locations in said building.

In one embodiment the flow transducer is configured to monitor changes in flow rates in said at least one pipe and adapted to transmit said changes in flow rate to said microcontroller.

In one embodiment the system comprises multiple motorised valves located at all water reservoirs internal to the building structure.

In one embodiment there is provided a non-return valve included to prevent flow reversal of water as per regulatory requirements.

In one embodiment the microcontroller comprises an intelligent learning system for continuous monitoring of fluid dynamics and deviations from usual, historical trends in said system.

In one embodiment the accumulator vessel is pressurised via the pump and adapted to allow water to flow until the mains water is up to a desired pressure.

In one embodiment, the accumulator vessel is in series with the mains water supply and used in the treatment of potable water.

In one embodiment there is provided a temperature, pressure and flow sensor as inputs to a microcontroller, which in turn, operate the smart valve and all internal valves with means to switch these valves on and off.

In one embodiment, multiple motorised valves can be placed internally in order to provide localised isolation of pipework sections/systems as an aid to determine if there are internal leaks in the system.

In one embodiment the system is adapted to be retrofit into existing plumbing systems. A retro fit involves the least amount intrusion and cost to the client.

In a further embodiment of the invention there is provided a water removal and pseudo-storage system adapted for controlling water supply in a building, said system comprising:
a valve adapted to isolate mains water supply from at least one water pipe;
at least one sensor and a controller adapted to monitor conditions in a building; and
a pump adapted to replace the static water within the supply pipe with air and relocate said water into an accumulator vessel.

In a further embodiment there is provided a water removal and pseudo-storage system adapted for use in a building structure, said system comprising:
a valve adapted to isolate mains water supply from at least one water pipe in the building structure; and
a pump adapted to push or pull sufficient water from the water pipe into an accumulator vessel.

In another embodiment of the invention there is provided valve for regulating water supply to a building comprising:
an inlet adapted to receive a mains water supply;
a controller adapted to receive control signals remotely, said signals control the valve to regulate the water supply pressure and/or flow rate to a desired set point; and
an outlet to provide a regulated water supply.

The smart valve embodiment is of a concentric modular form to allow one-handed installation/removal without the use of tools. The modular design allows the cascading of other water control hardware/instrumentation that complies with the modular form.

In one embodiment the valve is configured to receive the signals via wireless communication means.

In one embodiment the valve comprises a spring and rotating cam configured such that the rotating cam provides various degrees of compression on the spring dependent on the control signals.

In one embodiment the valve comprises a spring and linear screw configured such that the screw position provides various degrees of compression on the spring dependent on the control signals.

In one embodiment there is provided a communications module, said module adapted to relay valve status and metering data to a control database.

In one embodiment the valve comprises a winding current calculation algorithm configured to calculate the applied water pressure and/or the water flow rate to an end user.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:—

FIG. 1 illustrates a mechanical schematic of the invention according to a first and second embodiment of the invention.

FIG. 2 illustrates a three port valve of FIG. 1 shown in more detail

FIG. 3 illustrates a control layout overview of the system according to the present invention;

FIG. 4 illustrates a charge and a drain cycle flow diagram for the first and second embodiments of the invention of FIG. 1;

FIG. 5 illustrates a leak detection and flood prevention flow diagram for the first and second embodiments of the invention of FIG. 1;

FIG. 6 illustrates a modular base with a bonnet cap according to one aspect of the invention;

FIG. 7 illustrates the modular base with bonnet cap of FIG. 6 applied;

FIG. 8 illustrates a number of different embodiments of the modular base of FIGS. 6 and 7 in four basic formats;

FIG. 9 illustrates embodiment ‘A’ showing a generic concentric modular housing. The female entry underneath is hidden from view but has the same thread dimension as the male shown. Embodiment ‘B’ inverts the module to illustrate the female thread. Note that the O-ring seal is only applied to each male end of the module;

FIG. 10 illustrates two generic modules applied to the base system;

FIG. 11 illustrates a smart valve according to another embodiment of the invention shown in a flow-rate regulating format in FIGS. 11(a) and 11(c) and pressure regulating format in 11(c) and 11(d). FIGS. 11(a) and 11(b) utilise a right angled linked actuation via an adjustable cam whose position is varied using a stepper motor. FIGS. 11(c) and 11(d) illustrate a direct actuation via a screw thread mated to a hollow match threaded stepper motor shaft. In all cases, power is only applied to the stepper motor during the change of set point. The set-point reference is determined by the winding current magnitude during motor activation; and

FIG. 12 illustrates the smart valve of FIG. 11 applied to a concentric modular system.

### DETAILED DESCRIPTION OF THE INVENTION

The water removal and storage system of the present invention can be incorporated in a building adapted, for example a domestic, office or industrial building, to provide at least three different functions, namely:
1. Water removal, to reduce the risk of supply pipe freezing.
2. Leak detection/flood prevention.
3. Remote adjustment of water pressure setpoint.

Functions 1 & 2 to an extent, use a common hardware arrangement, controlled from a central processor or controller that allows interaction with a remote smart user interface and described in more detail below. Function 3 has commonality with a smart valve and applied microprocessor control via an RF or wired communications link.

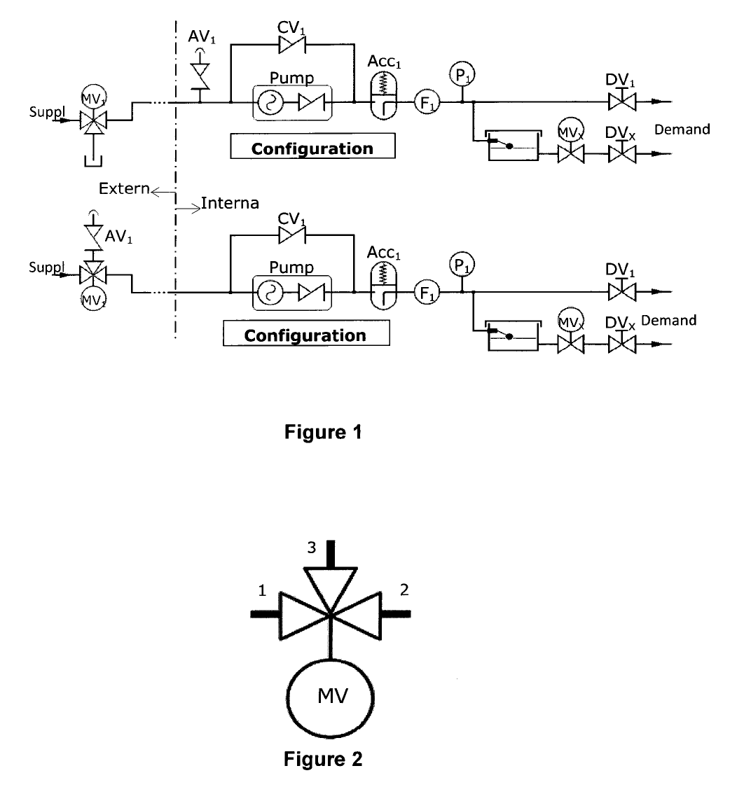

The schematic shown in FIG. 1 presents the mechanical schematic for both configurations of functions 1 & 2, according to two different embodiments of the invention. The mechanical component layout is provided in two configurations, “A” and “B” to accommodate positive and negative slope incline of the water mains supply pipe:
Configuration “A” is applied to an installation having a positive incline, i.e. the pump bore is at a higher elevation than the three-port valve bore (MV₁).
Configuration “B” is applied to an installation having a negative incline, i.e. the three-port valve bore is at a higher elevation than the pump bore.

The components making up the system of the present invention shown in FIG. 1 are described in more detail below and listed as follows:
MV₁: Motorized three-port valve.
MV_{X}: Motorized two-port valve.
Pump: Electric pump with integral check valve.
AV₁: Admittance valve. Allows air into the system for water drain.
CV₁: Check valve to prevent reverse flow.
Acc₁: Accumulator reduces the charge/discharge frequency.
F₁: Flow transducer, providing micro-controller input data.
P₁: Pressure transducer, providing micro-controller input data.
DV₁: Domestic valve, (any mains outlet, e.g. cold tap, shower (mains), etc).
DV_{X}: Domestic valve, (any header outlet, e.g. hot tap, pumped shower, etc).

The application, and component placement differs, pending the incline of the supply pipe work. To reduce the possibility of static water freezing within the supply line or causing damage due to a leak, the objective of the invention is to remove as much water as possible. The removal of water must be replaced by the admittance of air, via AV₁. Configuration “A” drains the water at the property boundary, the vent point being internal within the dwelling. Configuration “B” stores the removed water internal within the dwelling, the vent point being at the property boundary.

### First Embodiment

### Configuration “A”

The elevation of the pump bore is higher than that of the three-port valve bore, therefore water cannot be drawn from the pipe using the pump, it must be drained. Replacement volume is provided by air, admitted via AV₁.

### Second Embodiment

### Configuration “B”

The elevation of the pump bore is lower than that of the three-port valve bore, therefore water can be pumped into the accumulator rather than drained. Replacement volume is provided by air, admitted via AV₁.

The three-port motorized valve is shown in more detail in FIG. 2. The three-port motorized valve arrangement has two modes, of operation, “Normal” and “Active”. The motor is controlled by the micro-controller. In Normal Mode, the motor is de-energised, port #3 is shut port #1 is open to port #2. In Active Mode the motor is energised port #1 is shut, port #3 is open to port #2.

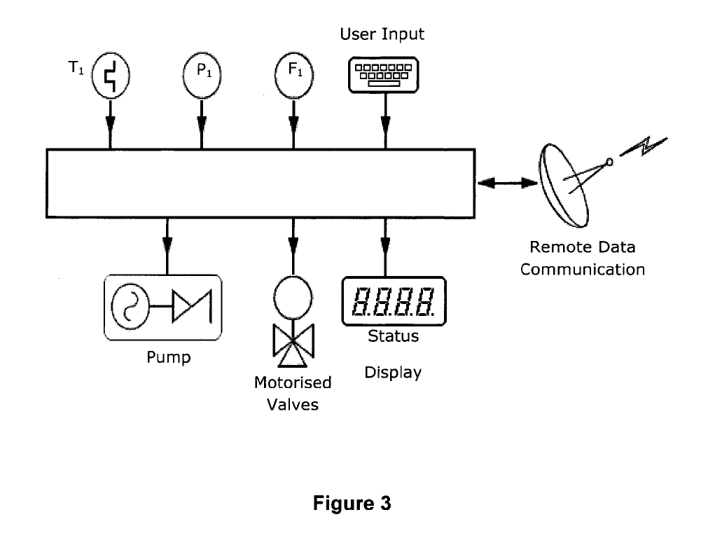

FIG. 3 illustrates a control layout overview of the system according to a preferred embodiment of the present invention. A microcontroller comprising a processor is in communication with all components of the system is adapted to transmit and receive control data. A flow transducer, a pressure transducer and a temperature transducer are adapted to be interfaced with the microcontroller wherein at least one transducer provides measurement data to the microcontroller to control operation of the valve and the pump. Data from the pressure and flow transducers, an outside air temperature sensor, and user input/configuration all provide their relevant status for processing by the micro-controller. The outcome of the sequence/algorithm determines the status of the pump, motorised valves, and status display. It will be appreciated that remote monitoring and smart control of the system is available via transmission protocols such as IEEE 802.11 or 3G.

### Accumulator & Pump Mechanism

Once pipe freeze or leak conditions are determined, isolation of supply and water removal from the pipe is imminent, irrespective of configuration type. Once removed, a method is required to determine the need to recharge the water supply pipe-work due to consumer demand.

Prior to supply isolation, the micro-controller determines whether the pressure is sufficient in the accumulator to monitor the need for recharge. If a pressure increase is determined, the boost pump will run, charging the accumulator, (and therefore the customer pipe-work) to the desired pressure.

A drop in pressure will indicate the need to recharge the system. The drain cycle rate depends on outside air temperature, (OAT), water flow rate, and consumer demand. A relatively small leak on the consumer pipework may be regarded as an inconvenience, causing the accumulator to slowly discharge. However, small leaks, whilst inconvenient, contribute to freeze protection, and this flow offset has the effect of decreasing the drain cycle rate.

### Charge/Drain Cycle Flow

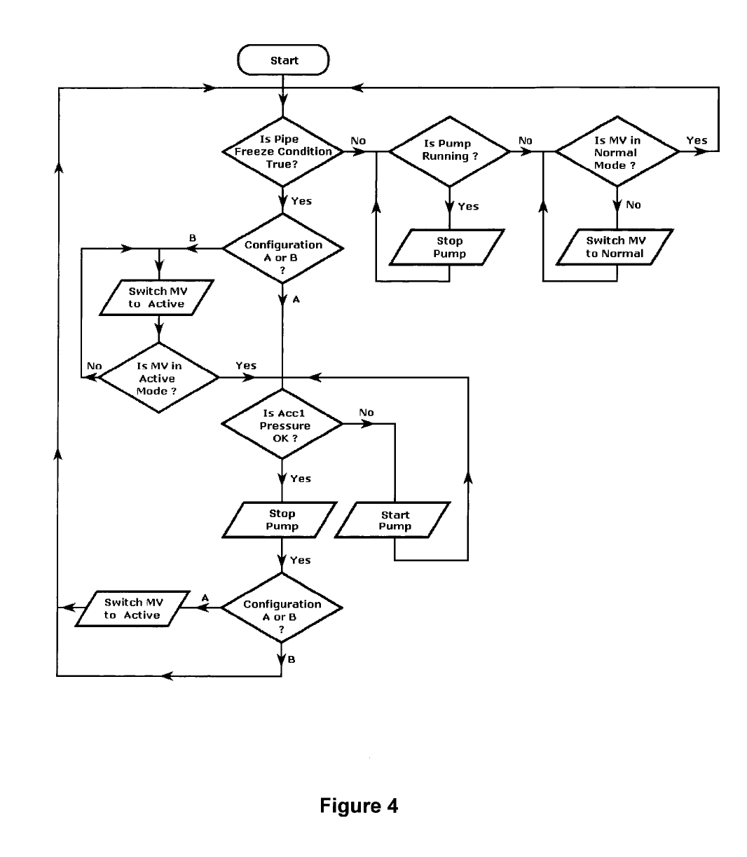

The charge and drain cycle flow diagram shown for both incline configurations ‘A’ and ‘B’ is illustrated in FIG. 4 for pipe freeze conditions. In operation, if no pipe freeze condition is detected the system will work as normal and water is delivered on demand. The microcontroller will continue monitoring for freeze conditions. “Pipe Freeze” true/false condition is determined by the micro-controller and can be programmed to be made dependant outside air temperature, (OAT), and water flow rate. A water demand from the occupier takes precedence over OAT, and renders the Pipe Freeze condition as false, recharging the system.

When freeze conditions are detected the system is adapted for the removal and storage of water from one or more supply lines and resupply of water stored on demand using the pump and the accumulator and controlled by the microcontroller, as shown in the flow diagram of FIG. 4.

### Leak Detection/Flood Prevention:

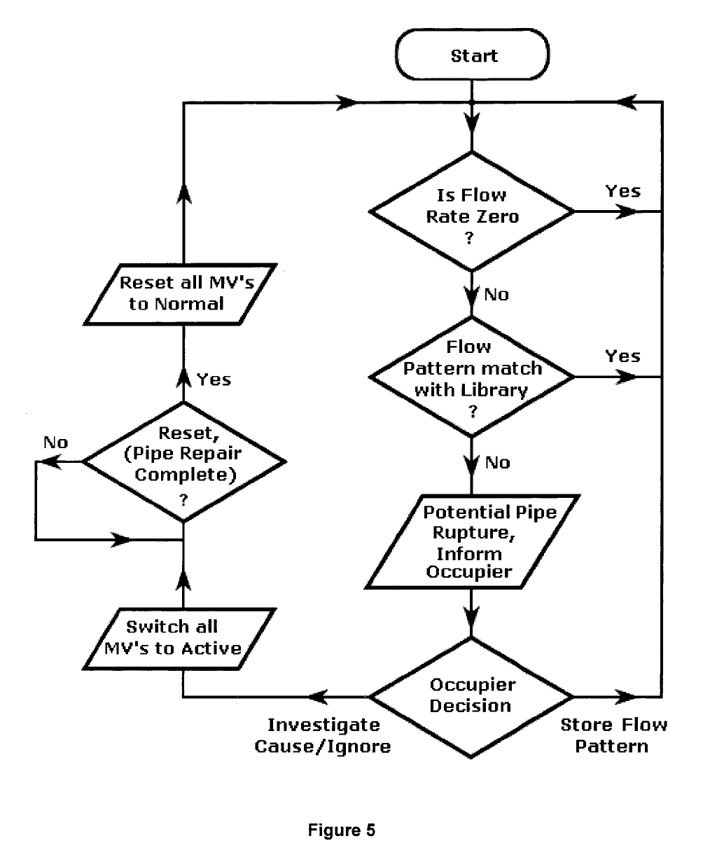

The flow diagram for the leak detection and flood prevention is illustrated in FIG. 5. The leak detection and flood prevention flow diagram is the same for both incline configurations ‘A’ and ‘B’. Leak detection is determined by the micro-controller and based on the data received from the pressure transducer, and in particular, the flow transducer. Data interpreted as a leak can alert the occupier or owner of the building, remotely if necessary. If the occupier wishes, he/she may acknowledge the flow pattern as an authentic water demand and the system stores that flow pattern in memory, and no preventative action is taken until another unrecognised flow pattern arises.

If the occupier or owner of the building decides to investigate the cause of the erratic flow, or no action is taken after a pre-set period, the system puts MV₁ into Active Mode, thereby shutting off the mains water supply. Remaining water reservoirs, such as the hot water cistern and header tank, may be isolated using two-port valves, represented by MV in FIG. 5. The system holds this isolation configuration indefinitely, until a reset command is received from the micro-controller. The reset command opens all the two-port valves and puts the three-port valve into normal mode.

### Modular System:

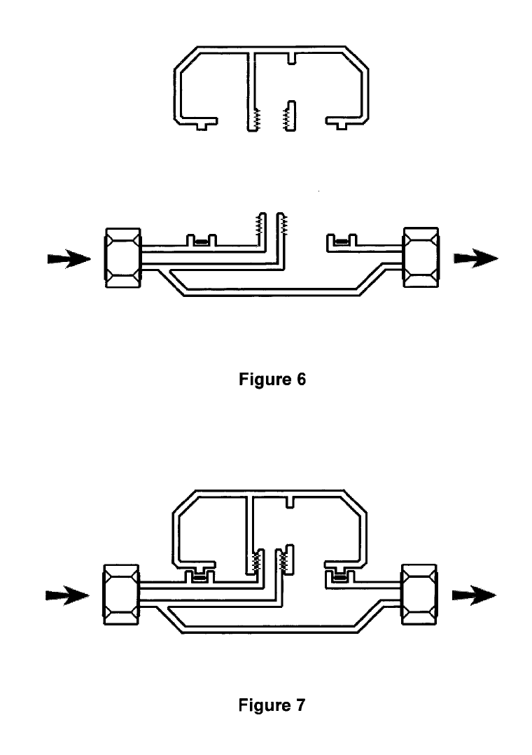

FIGS. 6 and 7 provides an illustration of a modular base and bonnet cap. The modular base requires installation by qualified personnel and sufficient tools to break into existing pipework. The base provides the foundation for a quick-fit concentric modular system, according to one aspect of the invention. FIG. 7 shows the modular system in its simplest form where the applied screw-on bonnet completes the fluid link. Note an o-ring seal on the base is in contact with the bonnet. Hand tightening of the bonnet is sufficient to provide a water seal at mains pressure. At this point, any further inclusion or upgrading of modules can be carried out with a minimal skill set and tools are not required.

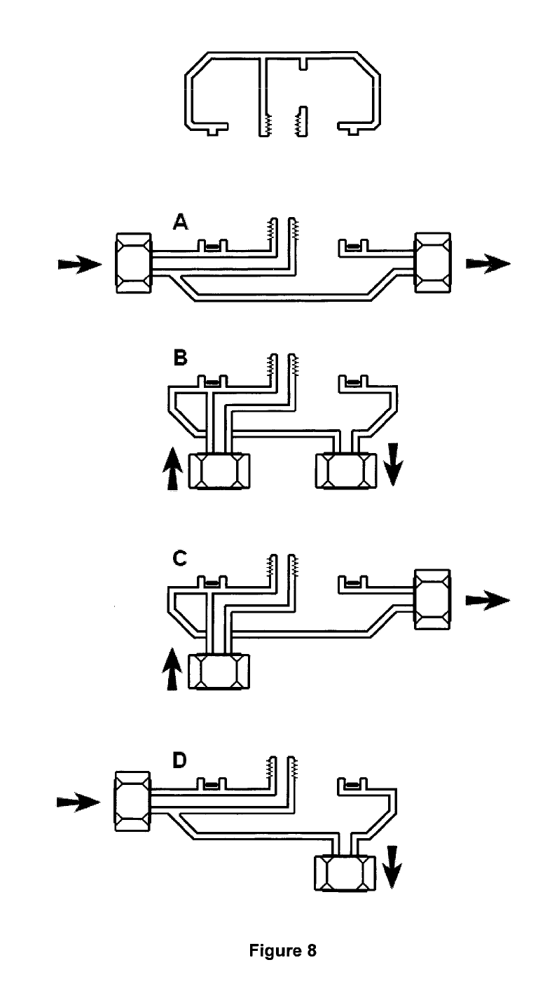

FIG. 8 illustrates a number of different embodiments of the modular base of FIGS. 6 and 7 in four basic formats. A number of base formats can be used to adapt to a variety of mains water pipe orientations. With the base installed, the platform can become standardised.

FIG. 9 shows an embodiment of the module from two different viewpoints. Viewpoint ‘A’ denotes the normal orientation of the module where the water inlet is hidden from view and sized at ½″ female BSP. The water outlet is a ½″ male BSP. Viewpoint ‘B’ denotes the module inverted to show the hidden female entry. At this point, the inner channel of the concentric module is apparent and the outer channel appears redundant.

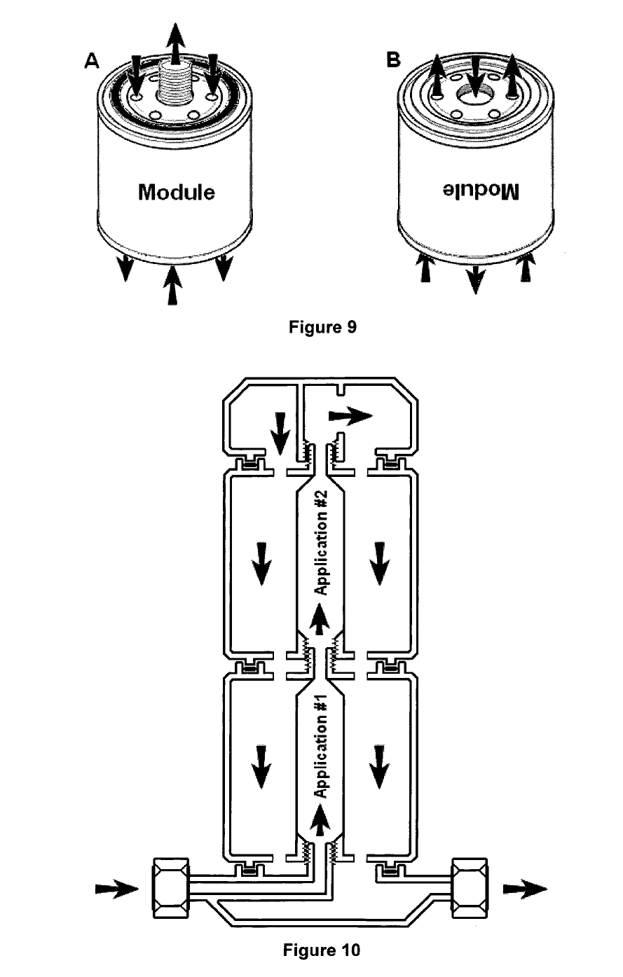

FIG. 10 shows an illustration of the assembled system using the module base, two module applications (variety of options such as filtering, water treatment, isolation valves, metering, etc), and the bonnet to provide the return flow on the outer channel of a concentric module stack.

### Smart Valve System

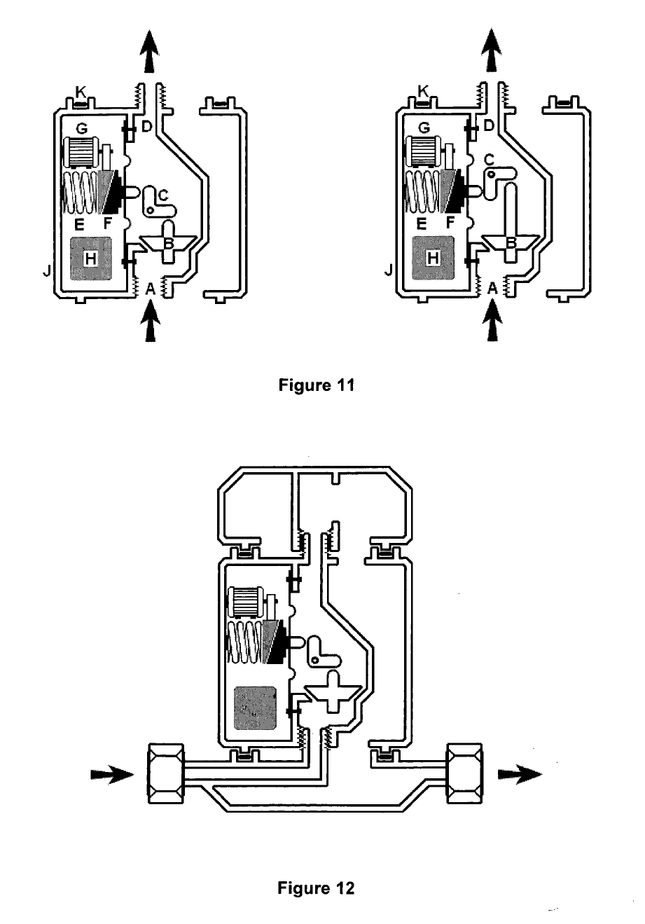

FIG. 11 illustrates the valve of FIG. 2 in more detail according to another embodiment of the invention shown in a flow-rate regulating format on the left, and a pressure regulating mode on the right. The valve, or ‘smart’ valve, comprises the following components:
A Water inlet (supply side).
B Poppet and stem assembly.
C Angle linkage allowing orientation of diaphragm at right angle to stem travel.
D Regulated pressure outlet.
E Primary Spring to provide counter-force to stem travel against inlet pressure. (Application of variable set point)
F Rotating cam to provide various degrees of compression on the spring that relate to chosen set point.
G Stepper motor to provide rotational motion to cam angle.
H Control System that contains: micro controller, motor interface, RF/wired communications interface, and lithium ion battery pack.
J Modular housing. Note that items D, E, F, and G are contained in a sealed compartment within the outer concentric section.
K O-Ring seal on the male side of the module housing.
L Secondary fixed spring for poppet counteraction.
M Bleed port required for flow regulation. Can be eliminated if poppet is prohibited (mechanical stop) from closing completely.
N Linear threaded screw that mates with the stepper motor hollow shaft with a matched thread.

The valve shown in FIG. 11 provides a modular smart valve to regulate water pressure or flow rate to a building, for example a house, apartment or office block. The set point is adapted to be configured remotely (wired or wireless). The water authority therefore has the capacity to regulate the water flow rate supplied to each individual consumer on the grounds of one or more of availability of supply, water grid configuration, and/or paid tariff.

The control system comprises a micro controller having one or more of the following functions:
1. Control the stepper motor to adjust the set point flow/pressure.
2. Determine the applied pressure set point from the consumed stepper motor winding current during a set point change.
3. Measure the lithium ion battery or power supply status.
4. Provide an interface to the remote communications module of choice fitted to the valve, (RF, Wifi, SMS, M2M, GSM, Bluetooth, wired Ethernet etc).
5. Apply the remote set point value.
6. Relay the valve status and metering data to a central database via remote communications.
7. Provide a remote communications link to any other modules used in the concentric module system.

In operation, the lithium ion power pack, or other suitable power means, can power the micro controller and the stepper motor rotation. The stepper motor rotation can be called upon only when there is a requirement to change the set point, the spring action is the primary force used to alter the valve stem position. The motor can utilise a high ratio gearbox to de-rate the motor and conserve power, a fast response to change the set point is not required. Alternate power sources have the capability to allow a greater impact of the stepper motor on the frequency of set point change. Solar cells and the inclusion of a module incorporating a micro turbine powered by water flow (not shown) are all possible with the utilisation of the smart valve and the concentric module system.

It will be appreciated that the valve can be applied to a water supply network that requires remote adjustment of Quality of Service (QoS) to customers in the form of pressure regulation. The valve shown in FIG. 11 provides a smart valve implementation at the entry point to each consumer and provides remote reduction/controlled pressure/flow to local customers increases the capacity of the water authorities to include customers on a greater radial distance from supply. The valve provides a soft-start mechanism that protects customer equipment from pressure transients and can allow a staged recovery in the event of a supply interrupt. Remote adjustment of pressure set point provides a staged or quantised level of customer pressure allowing a tariff metering method on the QoS provided is also possible. The stacked modular design, described with respect to FIGS. 6 to 10 allows for quick one-handed installation/removal without the use of tools. The stacked modular design also provides unlimited flexibility, simplifies upgrades, and accommodates a wide variety of components (filters, isolation valves, metering, etc) while the modular design is followed.

FIG. 12 shows an illustration of the smart valve incorporated into the base connection and the bonnet, as described with respect to FIGS. 6 to 10, completing a single module application system.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A water removal and storage system adapted for use in a building structure, said system comprising:
a valve adapted to shut off a mains water supply line from at least one water pipe in the building structure;
a pump adapted to push or pull sufficient water from the water pipe into the water storage vessel; and
a flow transducer, a pressure transducer and a temperature transducer interfaced with a microcontroller, wherein at least one transducer provides measurement data to the microcontroller to control operation of the valve and the pump.

2. The water removal and storage system as claimed in claim 1 wherein said system is configured to operate at a range of ambient temperatures whereby freeze pipe rupture is prevented in said at least one water supply line or pipe.

3. The water removal and storage system as claimed in claim 1 wherein the storage vessel is pressurised and adapted to allow water to flow on said at least one supply line or pipe until the mains water is up to a desired pressure.

4. The water removal and storage system as claimed in claim 1 wherein the temperature transducer is adapted to operate the valve with means to switch the valve on and off depending on the temperature conditions.

5. The water removal and storage system as claimed in claim 1 wherein the flow transducer is adapted to control the opening and closing of the valve thereby filling or emptying of the storage vessel.

6. The water removal and storage system as claimed in claim 1 wherein the flow transducer supplies data to the microcontroller to provide automated operation of filling or emptying of the storage vessel dependent on the data supplied to the microcontroller.

7. The water removal and storage system as claimed in claim 1 wherein the pressure transducer is adapted to compensate for water losses in the building pipe-work by running the system to maintain a charge in the vessel.

8. The water removal and storage system as claimed in claim 1 wherein the storage vessel comprises a bladder that is inflated at a slightly lower pressure than the water pressure, such that when water is forced into the storage vessel the bladder is compressed.

9. The water removal and storage system as claimed in claim 8 wherein when water is required the vessel will discharge by action of the bladder expanding forcing water out of the vessel for use.

10. The water removal and storage system as claimed in claim 1 wherein the flow transducer, the pressure transducer and the temperature transducer temperature sensor, a flow sensor and a pressure sensor combined to provide data that determine a water leak in said at least one water pipe.

11. The water removal and storage system as claimed in claim 1 wherein the system is adapted to be retrofitted into existing plumbing systems of said building structure.

12. The water removal and storage system as claimed in claim 1 comprising an admittance valve to facilitate water removal from the at least one water supply line or pipe.

13. The water removal and storage system as claimed in claim 1 comprising an accumulator or storage vessel to partially store removed water and provide a controlled pressure overhead in the system.

14. The water removal and storage system as claimed in claim 1 wherein the storage vessel is positioned substantially in series with a mains water supply and adapted to be used in the treatment of potable water.

15. The water removal and storage system as claimed in claim 1 comprising one or more motorised valves placed in situ in said building and adapted to determine a leak in said at least one supply line or pipe at different locations in said building.

16. The water removal and storage system as claimed in claim 1 wherein the flow transducer is configured to monitor changes in flow rates in said at least one pipe and adapted to transmit said changes in flow rate to said microcontroller.

17. The water removal and storage system as claimed in claim 1 comprising multiple motorised valves located at all water reservoirs internal to the building structure.

18. The water removal and storage system as claimed in claim 1 comprising a non-return valve included to prevent flow reversal of water in at least one of said supply lines.

19. The water removal and storage system as claimed in claim 1 wherein the microcontroller comprises an intelligent learning system for continuous monitoring of fluid dynamics and deviations from usual, historical trends in said system.

20. A water removal and storage system adapted for use in a building structure, said system comprising:
a valve adapted to shut off a mains water supply line from at least one water pipe in the building structure;
wherein the valve comprises a controller adapted to receive control signals remotely, said signals control the valve to regulate the water supply pressure and/or flow rate to a desired set point.

21. The water removal and storage system as claimed in claim 20 wherein the valve is configured to receive the signals via wireless communication means.

22. The water removal and storage system as claimed in claim 20 wherein the valve comprises a spring and rotating cam configured such that the rotating cam provides various degrees of compression on the spring dependent on the control signals.

23. The water removal and storage system as claimed in claim 20 wherein the valve comprises a spring having a remotely applied force configured such that the position of a linear screw provides various degrees of compression on the spring dependent on the control signals.

24. The water removal and storage system as claimed in claim 20 comprising a communications module, said module adapted to relay valve status and metering data to a control database.

25. The water removal and storage system as claimed in claim 20 wherein the valve comprises a winding current calculation algorithm that configured to calculate the applied water pressure and/or the water flow rate to an end user.

26. The water removal and storage system as claimed in claim 20 wherein the controller comprises a power supply.

27. A valve for regulating water supply to a building comprising:
an inlet adapted to receive a mains water supply;
a controller adapted to receive control signals remotely, said signals control the valve to regulate the water supply pressure and/or flow rate to a desired set point; and
an outlet to provide a regulated water supply.

28. The valve of claim 27 wherein the valve is configured to receive the signals via wireless communication means.

29. The valve of claim 27 wherein the valve comprises a spring and rotating cam configured such that the rotating cam provides various degrees of compression on the spring dependent on the control signals.

30. The valve of claim 27 wherein the valve comprises a spring and linear screw configured such that the screw position provides various degrees of compression on the spring dependent on the control signals.

31. The valve of claim 27 comprising a communications module, said module adapted to relay valve status and metering data to a control database.

32. The valve of claim 27 wherein the valve comprises a winding current calculation algorithm configured to calculate the applied water pressure and/or the water flow rate to an end user.

33. (canceled)

34. (canceled)
